(19) United States
(12) Patent Application Publication
(10) Pub. No.: US 2018/0063671 A1
(43) Pub. Date: Mar. 1, 2018

(54) SHORT-RANGE MATCHING MODULE USING BLUETOOTH TECHNOLOGY

(71) Applicant: Frank Tsu-Yuan MA, NEW TAIPEI CITY (TW)

(72) Inventor: Frank Tsu-Yuan MA, NEW TAIPEI CITY (TW)

(21) Appl. No.: 15/683,345

(22) Filed: Aug. 22, 2017

(30) Foreign Application Priority Data
Aug. 25, 2016 (TW) 105212941

(51) Int. Cl. H04W 4/00; H04W 4/06; H04W 8/18; H04W 52/02; G06F 17/30

(52) U.S. Cl. CPC H04W 4/008; H04W 4/06; G06F 17/30522; H04W 52/0203; H04W 8/18

(57) ABSTRACT

A short-range matching module using Bluetooth technology and inserted into a smart mobile device having a function of Bluetooth wireless communication. The matching module satisfies standard communication protocol with the Bluetooth core specification version 4.0 or higher. The matching module comprises a central processing unit for commanding, controlling, ordering and managing the smart mobile device and the personal data processing unit, matching condition management unit, matching broadcasting unit, matching search unit, matching identification unit, matching object display unit, matching object connection unit for individual and collaborative operation. Accordingly, the smart mobile devices comprising Bluetooth and the matching module which are within a short range can search for or send a broadcast message to each other. The users can further decide to connect with each other based on their willing.

### CROSS-REFERENCE TO RELATED APPLICATION

[symbol]

### BACKGROUND OF THE INVENTION

### Technical Field of the Invention

The present disclosure relates to a short-range matching communication device using low power consumption Bluetooth technology.

### Background

Nowadays, the communication software with significant market shares such as Line, wechat, etc. mainly uses mobile network or wifi to connect the users. The advantage of connecting the users through mobile network or wifi is that the connection between the users is unaffected by the distance. The disadvantage of connecting the users through mobile network or wifi is that the positioning error of the user position is of at least 50 meters. Accordingly, it is more difficult to apply connecting the users through mobile network or wifi to short-range connections such as high-accuracy positioning, short-range searches or push notifications.

The short-range wireless technology already developed and in use such as wi-fi, Bluetooth or Zigbee is applicable to the short-range connections. However, wifi has problems such as high power consumption and unstable connection quality due to the environment, and Zigbee is not wildly used in the smart mobile devices. Among all, Bluetooth is the only wireless communication technology that is applicable to the computers, mobile phones, and other appliances. The working distance of Bluetooth can be up to about 30 meters. Therefore, the inventor of the present disclosure believes that Bluetooth, which is a wireless communication technology, can be used as the basis of development of the short-range connections between the smart mobile devices. Accordingly, the inventor invented the short-range matching module.

### SUMMARY OF INVENTION

The object of the present disclosure is to provide a short-range matching module using Bluetooth technology to reach the purpose of short-range connections such as high-accuracy positioning, short-range searches or push notifications.

The short-range matching module using Bluetooth technology of the present disclosure is inserted into a smart mobile device having a function of Bluetooth wireless communication. The matching module satisfies standard communication protocol with the Bluetooth core specification version 4.0 or higher. The matching module comprises: a central processing unit for commanding, controlling, ordering and managing the smart mobile device and the personal data processing unit, matching condition management unit, matching broadcasting unit, matching search unit, matching identification unit, matching object display unit, matching object connection unit for individual and collaborative operations. Accordingly, the matching module comprised in the smart mobile device and the Bluetooth communication both within a short range can search for or send a broadcast message to each other.

The results of the present disclosure are described as below.

The matching module reaches the purpose of matching within a short range. Through short-range searching and push notifications, the matching module is able to find matching objects which satisfies the matching condition in the vicinity ranging from 30 to 50 meters

The matching module does not need to pair the smart mobile device in advance during the operation.

The matching module consumes low power.

The matching module can constantly perform push notifications, searches, receiving, and matching identifications as background processes in the smart mobile device without affecting other functions of the smart mobile device.

### BRIEF DESCRIPTION OF THE DRAWINGS

FIG. 1 is block diagram of one embodiment of the short-range matching module of the present disclosure.

FIG. 2 illustrates an interface of personal data processing of one embodiment of the short-range matching module of the present disclosure.

FIG. 3 illustrates an interface of the matching condition of one embodiment of the short-range matching module of the present disclosure.

FIG. 4 illustrates a menu of the matching objects of one embodiment of the short-range matching module of the present disclosure

FIG. 5 illustrates an interface for connecting the matching object of one embodiment of the short-range matching module of the present disclosure.

FIG. 6 illustrates an interface of information disclosure of one embodiment of the short-range matching module of the present disclosure.

### DETAILED DESCRIPTION OF THE INVENTION

Exemplary embodiments of the present application will be described in detail with reference to the accompanying drawings hereafter. The following embodiments are given by way of illustration to help those skilled in the art fully understand the spirit of the present application. Hence, it should be noted that the present application is not limited to the embodiments herein and can be realized by various forms. Further, the drawings are not precise scale and components may be exaggerated in view of width, height, length, etc. Herein, the similar or identical reference numerals will denote the similar or identical components throughout the drawings.

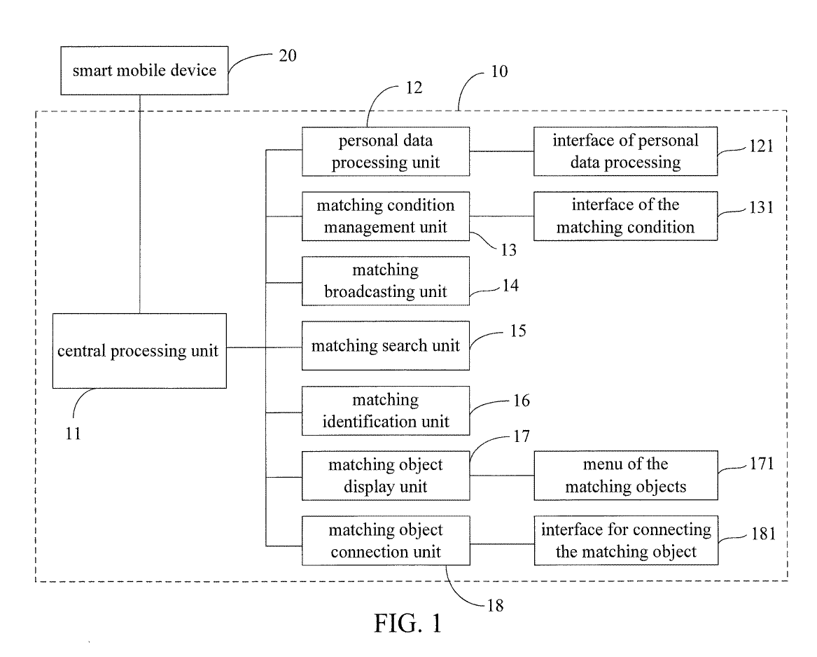

As shown in FIG. 1, the short-range matching module using Bluetooth technology 10 of the present disclosure is inserted into a smart mobile device 20 having a function of Bluetooth wireless communication. The matching module 10 satisfies standard communication protocol with the Bluetooth Core Specification version 4.0 or higher.

A central processing unit 11 for commanding, controlling, ordering and managing the smart mobile device 20 and the units described below for individual and collaborative operations.

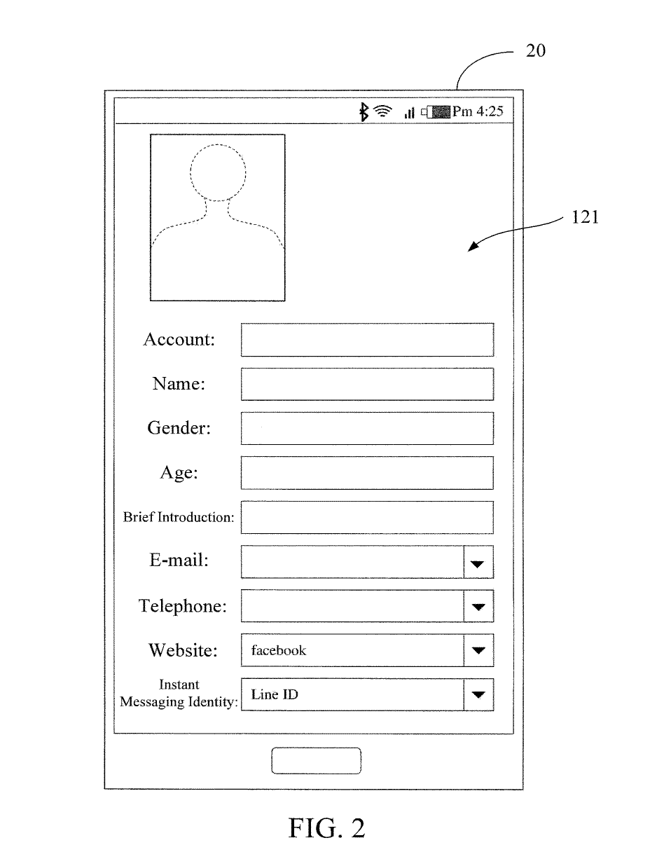

A personal data processing unit 12 receives and displays the personal information set up and edited such as added, corrected and deleted by the user through the interface of personal data processing 121 on the screen of the smart mobile device 20, which is shown in FIG. 2. The personal data processing unit 12 saves the personal information. The personal information comprises, but is not limited to, name, nickname, gender, height, weight, age, brief introduction, email address, instant messaging identity and websites such as face book and blog, etc.

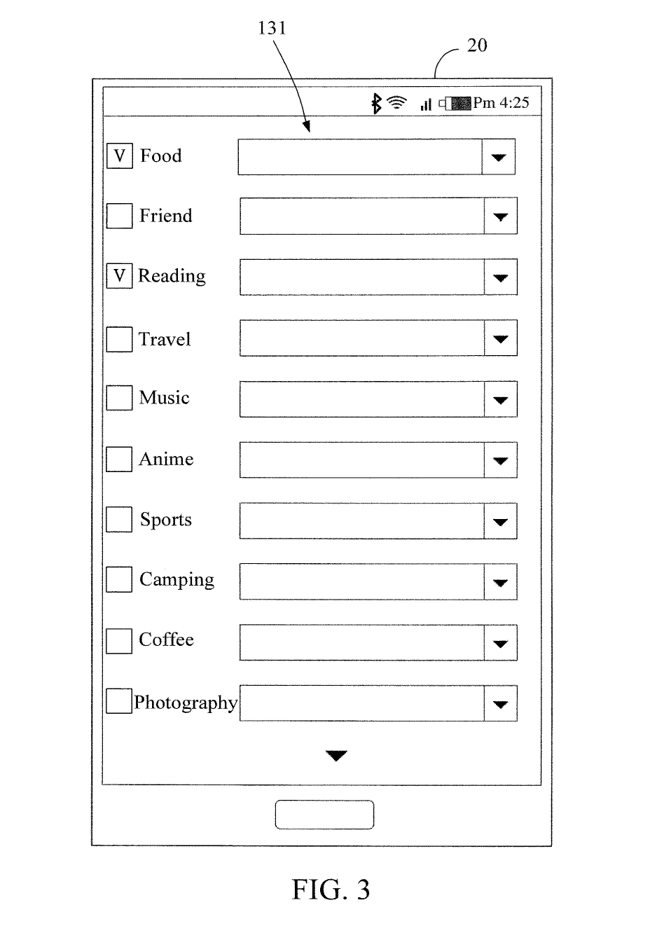

A matching condition management unit 13 receives and displays the matching condition set up and edited such as added, corrected and deleted by the user through the interface of the matching condition 131 on the screen of the smart mobile device 20, which is shown in FIG. 3. The matching condition management unit 13 saves the matching condition.

A matching broadcasting unit 14 broadcasts the matching condition mentioned above to another smart mobile device 20 comprising the matching module 10 and within a short range from 30 to 50 meters through the wireless communication satisfying Bluetooth Core Specification version 4.0 or higher.

A matching search unit 15 searches the matching condition broadcasted by another smart mobile device 20 comprising the matching module 10 and within a short range from 30 to 50 meters through the wireless communication satisfying Bluetooth Core Specification version 4.0 or higher.

A matching identification unit 16 compares and verifies whether the searched matching condition matches the broadcasted matching condition or not. If the searched matching condition matches the broadcasted matching condition, the broadcasted matching condition is appointed to be the matching objects.

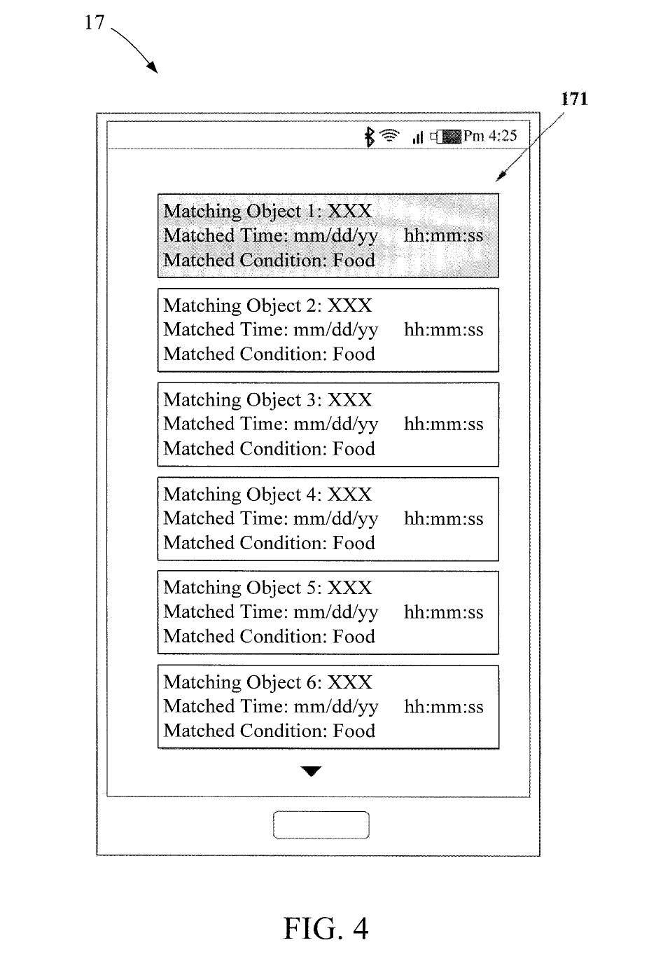

As shown in FIG. 4, a matching object display unit 17 displays a menu of the matching objects 171 through the screen of the smart mobile device 20. The menu of the matching objects 171 comprises all the information of the matching objects. The information comprises, but is not limited to, the date when the matching is established, the time, the matched matching condition. The user can further select the matching object that he/she wants to connect to through the menu of the matching object 171.

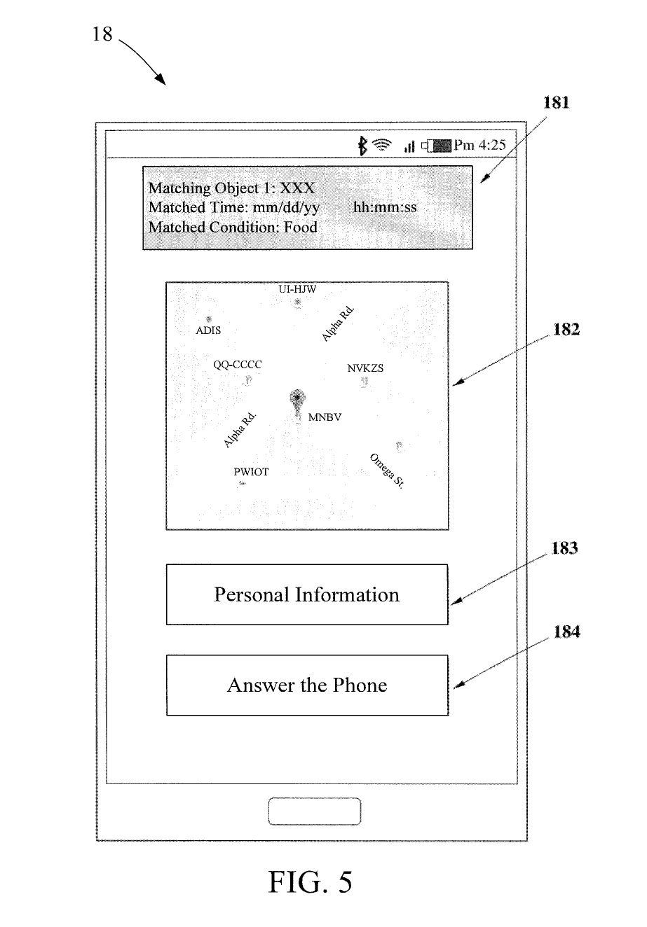

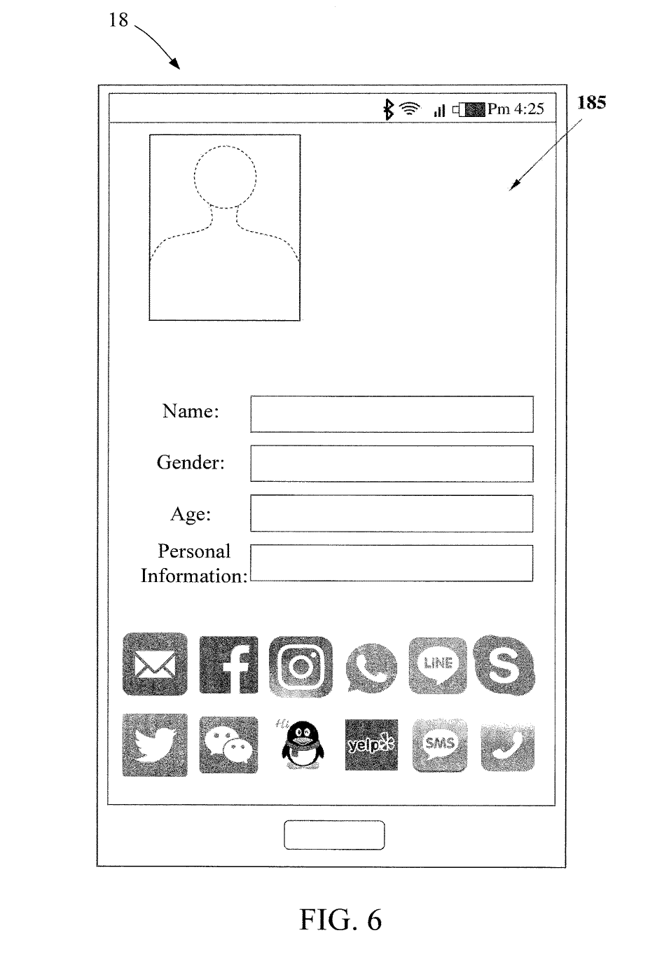

A matching object connection unit 18 displays an interface for connecting the matching object 181 through the screen of the smart mobile device 20. As shown in FIG. 5, the interface for connecting the matching object 181 displays information options of the selected matching object. The information options comprises, but is not limited to the location 182 where the matching object is located, personal information 183, and answer the phone or not 184. If the location 182 is selected, the matching object connection unit 18 shows the location where the matching object is located by digital map. As shown in FIG. 6, if the personal information 183 is selected, the matching object connection unit 18 shows the personal information of the matching object by information disclosure page 185 combining texts and images. The personal information comprises, but is not limited to, email address, instant messaging identity and websites such as face book and blog, etc. The option of answer the phone or not 184 can be shown in different colors or different brightness to show available to answer the phone or not available to answer the phone.

By the matching module satisfying standard communication protocol with the Bluetooth Core Specification version 4.0 or higher, the smart mobile devices comprising Bluetooth and the matching module which are within a short range can search for or send a broadcast message to each other. The users can further decide to connect with each other based on their willing.

What is claimed is:

1. A short-range matching module using Bluetooth technology and inserted into a smart mobile device having a function of Bluetooth wireless communication, the matching module satisfying standard communication protocol with the Bluetooth core specification version 4.0 or higher, and the matching module comprising:
a personal data processing unit receiving and displaying personal information set up and edited by an user through an interface of personal data processing on a screen of the smart mobile device, wherein the personal data processing unit saves the personal information;
a matching condition management unit receiving and displaying a matching condition set up and edited by the user through an interface of the matching condition on the screen of the smart mobile device, wherein the matching condition management unit saves the matching condition;
a matching broadcasting unit broadcastings the matching condition to another smart mobile device comprising the matching module and within a short range through the wireless communication satisfying Bluetooth core specification version 4.0 or higher;
a matching search unit searching the matching condition broadcasted by another smart mobile device comprising the matching module and within a short range through the wireless communication satisfying Bluetooth Core Specification version 4.0 or higher;
a matching identification unit comparing and verifying whether the searched matching condition matches the broadcasted matching condition or not, wherein a matched matching condition is appointed to matching objects;
a matching object display unit displaying a menu of the matching objects through the screen of the smart mobile device and receiving the matching object selected by the user through the menu of the matching object;
a matching object connection unit displaying an interface for connecting the matching object through the screen of the smart mobile device, wherein the interface for connecting the matching object displays information options of the selected matching object;
a central processing unit for commanding, controlling, ordering and managing the smart mobile device and the personal data processing unit, matching condition management unit, matching broadcasting unit, matching search unit, matching identification unit, matching object display unit, matching object connection unit for individual and collaborative operations.

2. The short-range matching module using Bluetooth technology according to claim 1, wherein the short range is between 30 and 50 meters.

3. The short-range matching module using Bluetooth technology according to claim 1, wherein the menu of the matching object comprises information of each matching object, wherein the information comprises a date when the matching is established, time, the matched matching condition.

4. The short-range matching module using Bluetooth technology according to claim 1, wherein the information options of the selected matching object comprises location where the matching object is located, personal information, and answer the phone or not.

5. The short-range matching module using Bluetooth technology according to claim 4, wherein the location where the matching object is located is shown by digital map.

6. The short-range matching module using Bluetooth technology according to claim 4, wherein the personal information of the matching object is shown by texts and images.
